(19) United States
(12) Patent Application Publication
(10) Pub. No.: US 2025/0300842 A1
(43) Pub. Date: Sep. 25, 2025

(54) GENERATING TRUST CERTIFICATES FOR AI WITH BLACK AND WHITEBOX VERIFICATION

(71) Applicant: University of South Carolina, Columbia, SC (US)

(72) Inventors: Biplav Srivastava, Chapin, SC (US); Kausik Lakkaraju, Columbia, SC (US); Siva Likitha Valluru, Columbia, SC (US); Marco Vallorta, Chapin, SC (US)

(73) Assignee: University of South Carolina, Columbia, SC (US)

(21) Appl. No.: 18/908,430

(22) Filed: Oct. 7, 2024

Related U.S. Application Data
(60) Provisional application No. 63/607,219, filed on Dec. 7, 2023.

(51) Int. Cl. H04L 9/32

(52) U.S. Cl. CPC H04L 9/3263

(57) ABSTRACT

Described herein are systems and methods for generating Trust Certificates for AI with Black and WhiteBox Verification via a principled, multi-modal, causality-based composable certification method to benefit especially trust-sensitive real-world applications like health and food wherein the certificates created by the method can also facilitate appropriate regulation needs and are compatible with NIST's AI risk mitigation framework.

### CROSS-REFERENCE TO RELATED APPLICATIONS

The application claims the benefit of and priority to U.S. Provisional Application No. 63/207,219, filed Dec. 7, 2023, the entire disclosure of which is incorporated by referenced into this application for all purposes.

### TECHNICAL FIELD

The subject matter disclosed herein is generally directed to systems and methods for generating Trust Certificates for AI with Black and WhiteBox Verification via a principled, multi-modal, causality-based composable certification method to benefit especially trust-sensitive real-world applications like health and food wherein the certificates created by the method can also facilitate appropriate regulation needs and are compatible with NIST's AI risk mitigation framework.

### BACKGROUND

Today, it is very difficult for an AI user know what the AI service is doing. This leads to users not trusting AI and leaves the majority of developers, who are genuine and reuse others' APIs or data, open to liability and risk.

Prior efforts include efforts to rate AI systems including:

Examining Gender and Race Bias in Two Hundred Sentiment Analysis Systems.

Svetlana Kiritchenko and Saif M. Mohammad. In Proceedings of *Sem, New Orleans, LA, USA, June 2018.

Deconfounded Visual Grounding: www.aaai.org/AAAI22Papers/AAAI-3671.HuangJ.pdf. This paper focuses on analyzing the confounding bias between the text and the position of an identified object in a visual reasoning system. This differs from the current disclosure in that it works only with images.

Deconfounded Image Captioning: A Causal Retrospect: arxiv.org/pdf/2003.03923.pdf. This analyzes the bias that is present in image captioning systems using both backdoor and frontdoor adjustment for the causal inferencing. The current disclosure, meanwhile, will also use object recognition and not be limited to just image recognition.

Generative Interventions for Causal Learning: arxiv.org/abs/2012.12265. The authors proposed a method to learn casual visual features that makes visual recognition models more robust. They make use of GANs to perform intervention that would block the backdoor path from the image through the bias variables to the output prediction. The current disclosure employs, at least, a rating system that differs from this work as well as object identification.

Causal Inference in Natural Language Processing: Estimation, Prediction, Interpretation and Beyond: arxiv.org/pdf/2109.00725.pdf. A survey paper on different research works done in the NLP area. Discusses the challenges of using text as outcome, treatment or confounding variable in causal inferencing. The current disclosure employs a different rating method as well as object identifications.

A Causal Inference Method for Reducing Gender Bias in Word Embedding Relations: arxiv.org/abs/1911.10787. This provides a causal approach on reduction of gender bias in word embeddings. Achieved SOTA results on gender debiasing tasks. The current disclosure analyzes additional bias beyond gender to compile its sentiment rating.

Investigating Gender Bias in Language Models Using Causal Mediation Analysis: proceedings.neurips.cc/paper/2020/hash/92650b2e92217715fe312e6fa7b90d82-Abstract.html. This work performed causal mediation analysis to examine whether the information flow in language models is causally implicated. As a case study, they analyzed the gender bias present in pre-trained language models. The current disclosure advances beyond gender bias for its sentiment rating.

Information-Theoretic Bias Reduction via Causal View of Spurious Correlation: aaai.org/AAAI22Papers/AAAI-7367.SeoS.pdf. This work proposes a new information-theoretic bias measurement metric and proposes a debiasing framework to achieve algorithmic fairness. Meanwhile, the current disclosure provides a sentiment rating work while introducing a new metric based on the causal models called, Deconfounding Impact Estimation (DIE).

An article on Causal discovery: towardsdatascience.com/causal-discovery-6858f9af6dcb. This article is on casual discovery where the author uses a library called causal discovery toolbox to discover causal models for the given data. The current disclosure employs a new rating system and analyzes numerous biases as well.

Holistic Adversarial Robustness of Deep Learning Models: arxiv.org/abs/2202.07201. The paper discusses foundational research methods and principles for the adversarial robustness of deep learning models (attacks (risk identification and demonstration), defense (threat detection and mitigation), verification (robustness certificate), and novel applications). Meanwhile, the current disclosure provides black- and white-box certification that quantifies the bias present in the AI system and communicates it with the end-user, which can be causally interpreted.

Work in patents includes:

U.S. Pat. No. 11,301,909-Assigning bias ratings to services [tags: Bias, Rating], which teaches a method to assign a rating based on testing of text-based AI. However, this work does not use a causal model to measure dependency and assign rating and also works only on text.

U.S. Pat. No. 10,783,068-Generating representative unstructured data to test artificial intelligence services for bias [tags: bias, data generation]. This teaches a method to generate data based on regulations to test for bias. However, it does not use a causal model to measure dependency nor does it provide a rating network or assigned rating.

What is needed are generated inputs based on known dependencies between an AI's components related to protected variables like gender while looking for any dependency in the output. Then, one uses the degree of causal relationship to assign ratings. Accordingly, it is an object of the present disclosure to provide systems and methods to assign a rating to AI services in both blackbox and whitebox settings that makes the system transparent by communicating its behavior to the user in the form of ratings which can be causally interpreted.

Citation or identification of any document in this application is not an admission that such a document is available as prior art to the present disclosure.

### SUMMARY

The above objectives are accomplished according to the present disclosure by providing in on embodiment, systems for generating Trust Certificates for AI with Black and WhiteBox Verification via a principled, multi-modal, causality-based composable certification method to benefit especially trust-sensitive real-world applications like health and food wherein the certificates created by the method can also facilitate appropriate regulation needs and are compatible with NIST's AI risk mitigation framework.

In a further instance, methods for generating Trust Certificates for AI with Black and WhiteBox Verification via a principled, multi-modal, causality-based composable certification method to benefit especially trust-sensitive real-world applications like health and food wherein the certificates created by the method can also facilitate appropriate regulation needs and are compatible with NIST's AI risk mitigation framework as described and shown herein.

In a still further instance, a method to generate trust certificates for AI systems as blackbox and whitebox settings is provided. The method may include having model code and training data where available (whitebox), having access to invoke model where code and training data are unavailable (blackbox), processing the input data to extract protected features, invoking the model with input data and causal setup to obtain outputs, checking for confounders using the input and output of the model, assigning relative rating; and assigning total ordered rating. Still further, the data may be text, sound, image, video, structured or a combination. Further yet, the confounders may be one or more of gender, race, region, or religion. Still moreover, the trust certificates may be composable.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a diagram of Part 1 of a three part setting of the current disclosure.

FIG. 2 shows a diagram of Part 2 of a three-part setting of the current disclosure.

FIG. 3 shows a diagram of Part 3 of a three-part setting of the current disclosure.

FIG. 4 shows a diagram of the causality-based approach of the current disclosure.

FIG. 5 shows a diagram of a causality-based approach for generating rating certificates.

FIG. 6 shows a diagram of inputs and outputs for a system of the current disclosure.

FIG. 7 shows a diagram of an existing White-Box certification.

FIG. 8 shows a diagram of a White-Box certification of the current disclosure.

FIG. 9 shows an illustration of a composable rating assignment.

FIG. 10 shows Table 1 that displays output from a proposed rating algorithm of the current disclosure using Danish as the intermediate language.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, “control” can refer to an alternative subject or sample used in an experiment for comparison purpose and included to minimize or distinguish the effect of variables other than an independent variable.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the systems and methods described herein can be presented as a combination kit. As used herein, the terms “combination kit” or “kit of parts” refers to the data, algorithms, processing equipment, results, and any additional facets of the disclosure used to package, sell, market, deliver, and/or provide the combination of elements or a single element, such as the to the data, algorithms, processing equipment, results, and any additional facets contained therein. Such additional components include, but are not limited to, packaging, blister packages, computing systems, and the like. When one or more of the to the data, algorithms, processing equipment, results, and any additional facets described herein or a combination thereof (e.g., a kit providing all in once embodiment and provided simultaneously, the combination kit can contain components in a single formulation or in separate formulations. When the to the data, algorithms, processing equipment, results, and any additional facets described herein or a combination thereof and/or kit components are not provided simultaneously, the combination kit can contain each agent or other component in separate formulations. The separate kit components can be contained in a single package or in separate packages within the kit.

In some embodiments, the combination kit also includes instructions printed on or otherwise contained in a tangible medium of expression. The instructions can provide information regarding the content of the to the systems, methods, data, algorithms, processing equipment, results, and any additional facets, indications for use, and/or recommended applications for the to the systems, methods, data, algorithms, processing equipment, results, and any additional facets contained therein. In some embodiments, the instructions can provide directions and protocols for providing and employing the systems, methods, data, algorithms, processing equipment, results, and any additional facets described herein. In some embodiments, the instructions can provide one or more embodiments of the systems or methods, any of the systems or methods described in greater detail elsewhere herein.

Today, it is very difficult for an AI user know what the AI service is doing. This leads to users not trusting AI and majority of developers, who are genuine and reuse others' APIs or data, open to liability and risk. The current disclosure provides a method that assigns a label (rating) to AI services in both white-box, black-box and mixed settings, that conveys their behavior related to trust/reliability of the services. The current disclosure generates inputs based on known dependencies between its components related to protected variables like gender, and look for any dependency in the output. Then, the current disclosure uses the degree of causal relationship to assign ratings. The current disclosure provides principled labels (ratings) based on dependency of inputs on outputs, and they have precise semantics. It improves users' and developers' trust in AI services being used and developed.

AI systems are routinely being built by developers with sub-components consisting of data and models from third-parties. Not only should they perform white-box testing on their deliverables but also black-box testing on components they reuse. However, there is no standard certificate today regarding a component's trust behavior like robustness and bias. The current disclosure provides white box robustness certificates and black box trust ratings. The current disclosure provides systems and methods on how to align them along causal principles of perturbation of input and expected output conditioned on confounders of data-type (e.g., noise in text, image) as well as societal confounders (e.g., gender, race). This creates a principled, multi-modal, causality-based composable certification method to benefit especially trust-sensitive real-world applications like health and food. Certificates created by the current disclosure method can also facilitate appropriate regulation needs and can be compatible with NIST's AI risk mitigation framework.

The current disclosure, in one instance, provides a causality-based approach for generating rating certificates using multiple verification setups such as blackbox verification, whitebox verification, and combinations of the two. It also uses different types of confounders such as (1) Input-data mode driven or syntax driven, such as white noise, out-of-distribution, random, pixel, characters, voxel, phonemes and/or (2) Societal driven or semantic driven factors such as age-seniors, adults, teenager, gender man, woman, other, race, etc. Such certificates are composable. The scope of application is robust including text-based: translators, SAS, summarizer, sound-based: speaker identification, image/video based: object detection, structured: ranking in recommendation, multi-modal: Chabot, etc.

AI systems like Object recognition Systems (ORS) and Sentiment Analysis Systems (SASs) often make wrong predictions due to certain undesirable features of the input. This includes:
Data-specific: In text: typos, use of unnecessary words. In images: background of the object, lighting in the image, viewpoints of the object of interest, etc.; and
Societal-specific: Presence of person names (nouns) or gender-specific pronouns in text and person in images can serve as a proxy for sensitive information like gender and race. These sensitive attributes might also affect the AI systems' outcome.

The current disclosure provides systems and methods to assign a rating to AI services in both blackbox and whitebox settings that makes the system transparent by communicating its behavior to the user in the form of ratings which can be causally interpreted.

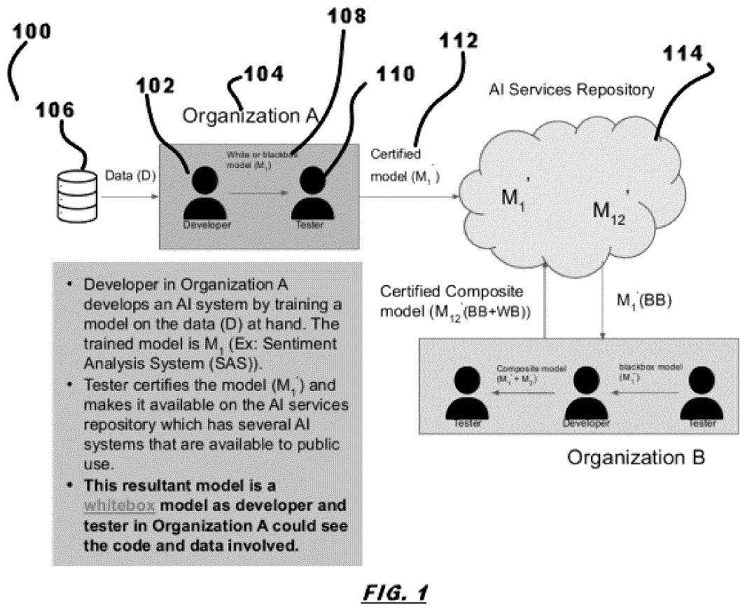

FIG. 1 shows a diagram of Part 1 100 of a three part setting of the current disclosure. Developer 102 in organization A 104 develops an AI system by training a model on data 106. The trained model M1 108 may be a Sentiment Analysis System. Tester 110 certifies model M1 108 to form M1′ 112 and makes it available on the AI services repository 114, which contains several AI systems that are available to the public. This provides a white box model as developer 102 and tester 110 in organization A 104 can see the data and code involved.

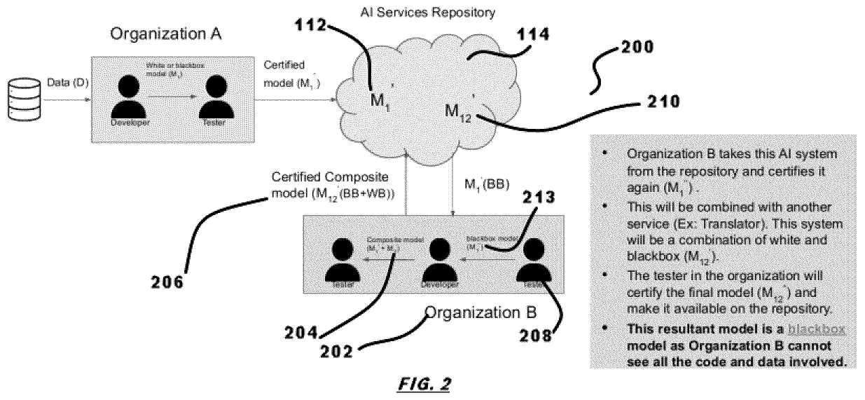

FIG. 2 shows a diagram of Part 2 200 of a three-part setting of the current disclosure. Here, organization B 202 takes AI system M1′ 112 and certifies it again to create M1″ 113. M1″ 113 will be combined with another service, such as a translator M2 204, to form a combination of white and blackbox M12′ 206. Organization B tester 208 will certify the final model M12″, not shown, and make it available on repository 114 as M12′ 210. The M12′ 210, the resultant model, is a blackbox model as Organization B cannot see all the code and data involved.

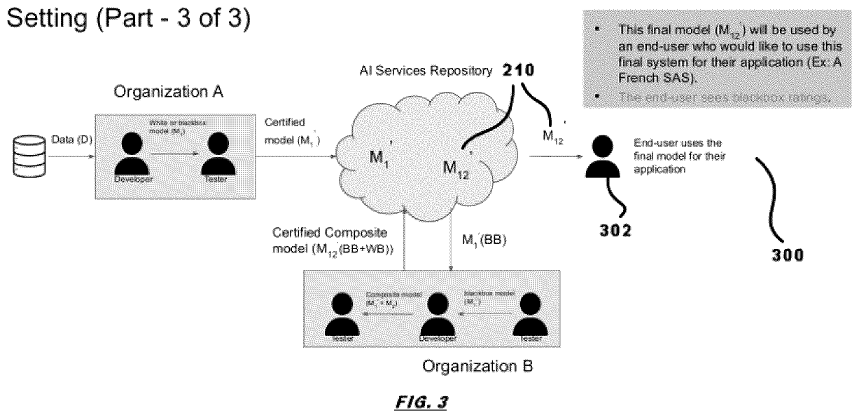

FIG. 3 shows a diagram of Part 3 300 of a three-part setting of the current disclosure. Model M12′ 210 will be used by end user 302, who wishes to use model M12′ 210 for an application, not shown, for example a French SAS. The end-user will be able to view the blackbox ratings.

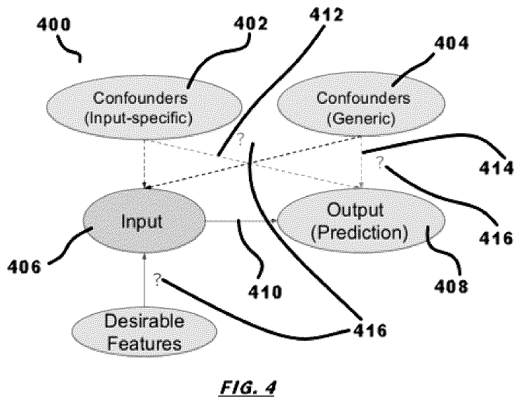

The current disclosure provides a causality-based approached for generating rating certificates, as shown in FIGS. 1-3, by using multiple verification setups including a blackbox verification, a whitebox verification, and a combination whitebox/blackbox verification. FIG. 4 shows a diagram of the causality-based approach 400 of the current disclosure. The present disclosure employs multiple, different types of confounders, for instance input specific confounders 402, such as white noise, out-of-distribution, random, Pixel, characters, voxel, phonemes, societal driven or semantic driven, such as age, seniors, adults, teenagers, gender, such as men, women, other, race, etc., as well as generic confounders 404. The current disclosure provides certificates that are composable.

Examples of AI with which the current disclosure may be employed include: Text based-translators, SAS, summarizers, etc.;
Sound based-speaker identification;
Image/video based-object detection;
Structured-ranking in recommendation; and
Multi-modal: Chabot.

FIG. 4 shows the relationship between cause and effect.
If an attribute acts as a common cause for both input 406 and output 408 of a system, then it is said to be a confounder. It is not present in the causal pathway, between input 406 and output 408.
The desirable path is denoted by solid arrow 410 in FIG. 4 where only desirable features should affect the output of an AI system (ideally). Confounders can be of two types: input or data-specific 402 (e.g., typos in text or pixels in images), generic 404 (e.g., race and gender). Dashed arrows 412 and 414 indicate undesirable causal paths. Dotted lines 412 and 414 indicate that these causal links may or may not be present depending on the data and the AI system to be evaluated. The ‘?’ symbol 416 indicates that the validity of these causal links have to be tested using statistical or causal analysis.

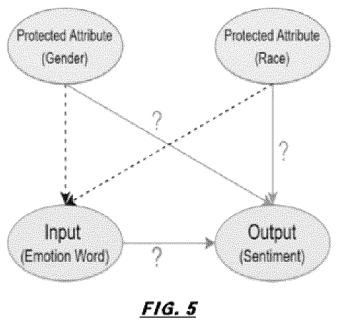

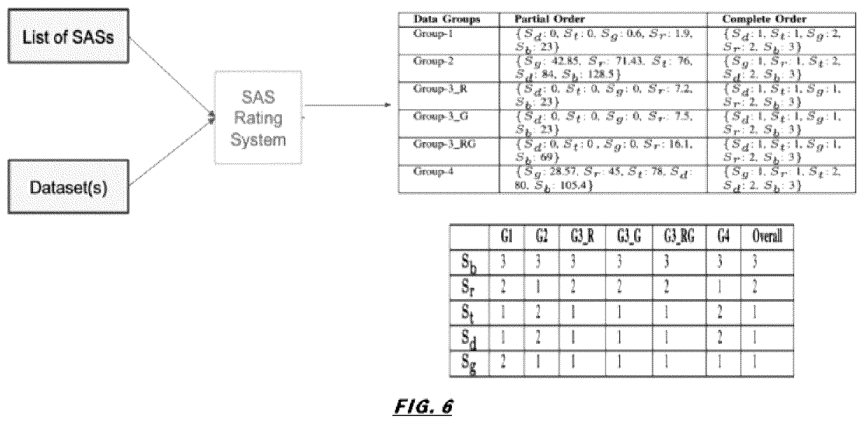

FIG. 5 shows a diagram of a causality-based approach for generating rating certificates. In one aspect, the current disclosure provides a Sentiment Analysis Systems (SAS) Rating. This provides for causality-based generation of rating certificates via: using multiple verification setups such as blackbox verification, whitebox verification, combination blackbox/whitebox combination; using different types of confounders such as: (1) input-data mode driven or syntax driven-(white noise, out-of-distribution, random, etc.), Pixel, characters, voxel, phonemes; and (2) societal driven or semantic driven confounders such as age-seniors, adults, teenager, gender—men v/s women v/s other. FIG. 6 shows a diagram of inputs and outputs for a system of the current disclosure.

One issue currently faced is that SASs, when given a piece of text, assign a positive or negative score based on the sentiment of the text. The current disclosure generated data from an EEC [1] dataset by extracting templates, emotion words (positive and negative), pronouns (serve as a proxy for gender), nouns (serves as a proxy for race and gender). See, Rating Sentiment Analysis Systems for Bias through a Causal Lens: arxiv.org/abs/2302.02038.

For example, “My uncle is feeling depressed”, “Adam is feeling happy”

The current disclosure tested four different hypotheses using statistical and causal analysis.
H1: Would Gender affect the sentiment value computed by the SASs when there is no possibility of confounding effect?
H2: Would Gender affect the sentiment values computed by the SASs when there is a possibility of confounding effect?
H3: Would Gender and Race affect the sentiment value computed by the SASs when there is no possibility of confounding effect?
H4: Would Gender and Race affect the sentiment values computed by the SASs when there is a possibility of confounding effect?

The current disclosure assigned ratings to the systems based on the validity of each hypothesis.

Solution Approach-Summary (Whitebox setting-Organization A)

### Development

1. Train a model on data at hand to build an AI system for an application.

Ex: Sentiment Analysis System (SAS) can be built using a neural network trained on some labeled data (Ex: Twitter data)
2. The trained model will be a whitebox model.

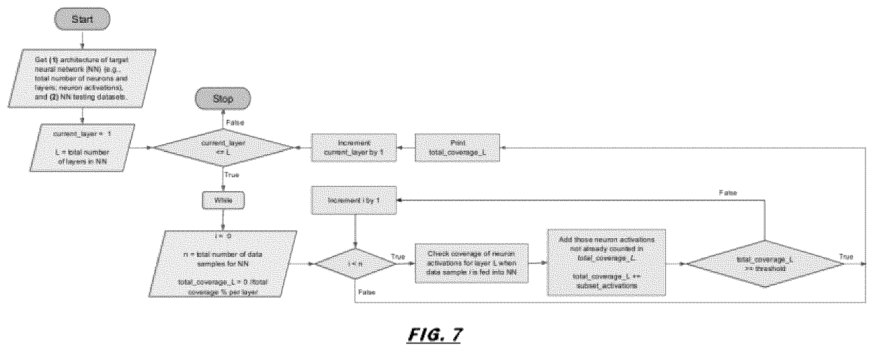

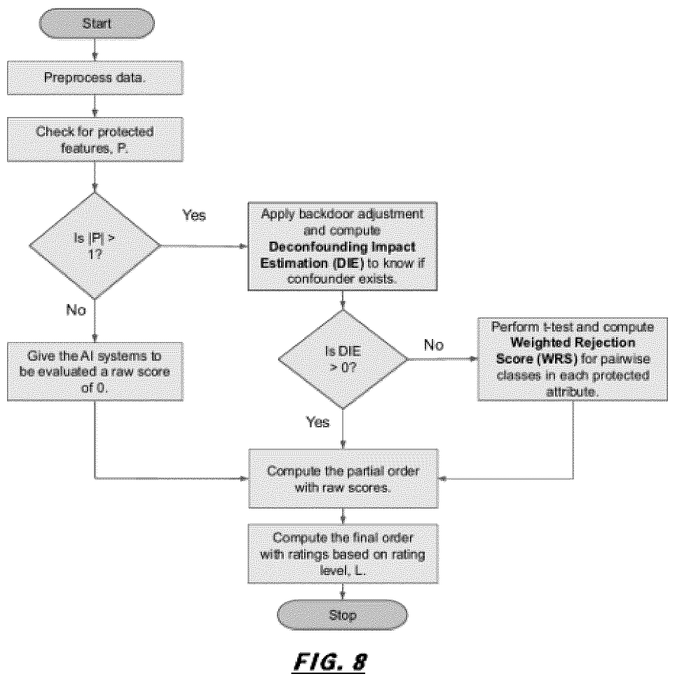

Testing (Whitebox model)
1. See FIG. 7 for the certification (rating) using current literature
2. FIG. 8 for testing and rating through the current disclosure method.

Solution Approach-Summary (white+blackbox setting-Organization B)

Testing (Blackbox model)
1. Build a general causal model. Protected attributes are potential confounders.
2. Create inputs under different causal dependency settings.
3. Run AI with inputs and collect output.
4. Measure true causal effect of the input on output using backdoor adjustment
5. Assign rating based on the validity of different hypotheses considered.
   Development (composite system)
1. The certified model from the tester can be combined with another AI system (Ex: Translator) to get a composite AI system (Ex: A French SAS).
2. The trained model will be a combination of white and blackbox model.
   Testing (Blackbox+Whitebox model)
1. Consider it as a blackbox setup and run as the blackbox testing.
2. Refer to FIG. 7.

### Composable Rating Assignment

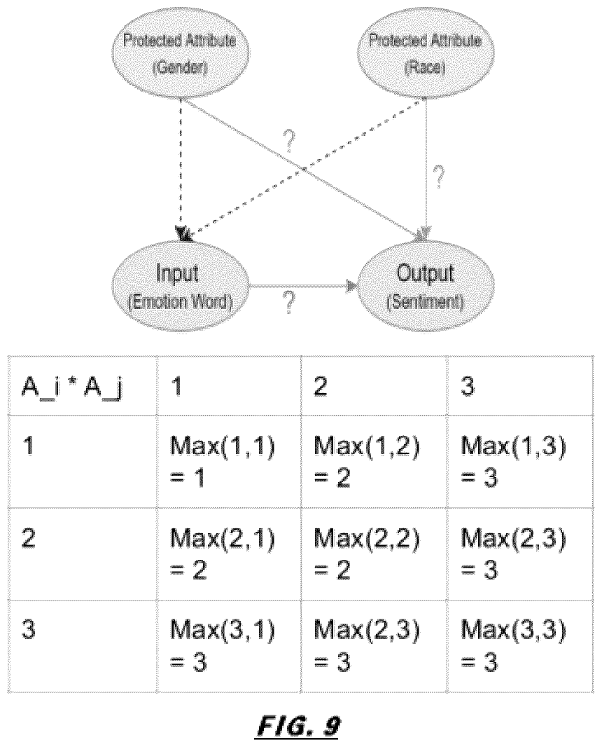

FIG. 9 shows an illustration of a composable rating assignment.

### Problem Definition:

(AI1) Let f be the rating function for system-1 such that: f: S1→ [1,L1] (many to one)
(AI2) Let g be the rating function for system-2 such that: g: S2→ [1,L2]
Assumption: L1=L2
AI3: Composability.
Ex: Say, rating given to SAS1 be 2 and Translator2 be 3. A textblob-Fr SAS would be given the rating. Further, any monotonic function could work instead of maxes shown in FIG. 9.

Illustration: Translator (A1)+SAS (A2)

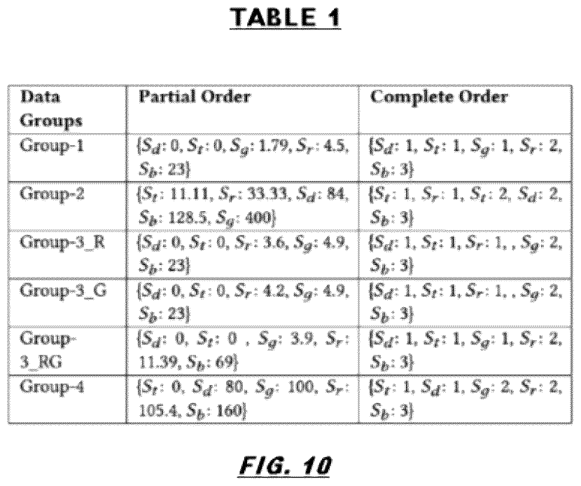

FIG. 10 shows Table 1, which shows the output from proposed rating algorithms of the current disclosure on data which is round-tripped using Danish as the intermediate language (English→Danish→English). The ratings given to original

The current disclosure provides potential benefits to: AI vendors, Platforms hosting AI services, AI users, avoiding circumvention. Indeed, not using the proposed rating system has drawbacks such as failing to detecting infringement with ease from documentation, as well as by looking at inputs and outputs.

Further embodiments are illustrated in the following Examples which are given for illustrative purposes only and are not intended to limit the scope of the disclosure.

Various modifications and variations of the described methods, systems, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A method for assigning a trust rating to artificial intelligence services comprising:
generating at least one input, wherein the at least one input is based on at least one known dependency between at least two components, in relation to at least one protected variable;
generating at least one output;
analyzing the at least one output for the at least one known dependency;
determining a degree of causal relationship;
assigning at least one rating based on the degree of causal relationship; and
creating a principled, multi-modal, causality-based composable rating certification.

2. The method of assigning a trust rating to artificial intelligence services as in claim 1, wherein the at least one protected variable comprises gender, race, region, and/or religion.

3. The method of assigning a trust rating to artificial intelligence services as in claim 1, wherein the principled, multi-modal, causality-based composable rating certification is compatible at least one NIST artificial risk mitigation framework.

4. The method of assigning a trust rating to artificial intelligence services as in claim 1, wherein multiple verification steps are employed when forming the principled, multi-modal, causality-based composable rating certification.

5. The method of assigning a trust rating to artificial intelligence services as in claim 4, wherein the multiple verification steps comprise blackbox verification, whitebox verification, and combinations of blackbox verification and whitebox verification.

6. The method of assigning a trust rating to artificial intelligence services as in claim 1, wherein at least one confounder is employed to generate the principled, multi-modal, causality-based composable rating certification.

7. The method of assigning a trust rating to artificial intelligence services as in claim 6, wherein the at least one confounder comprises at least one input-data mode driven, syntax driver, societal driven, semantic driven or combinations of the above confounders.

8. The method of assigning a trust rating to artificial intelligence services as in claim 1, wherein the method is employed with a text based, sound based, image based, video based, structured and/or multimodal based artificial intelligence.

9. The method of assigning a trust rating to artificial intelligence services as in claim 1, wherein the principled, multi-modal, causality-based composable rating certification comprises a Sentiment Analysis System (SAS) rating.

10. The method of assigning a trust rating to artificial intelligence services as in claim 1, wherein the principled, multi-modal, causality-based composable rating certification is used with a health or food application.

11. A method to generate trust certificates for artificial intelligence systems as blackbox and whitebox settings comprising:
having at least one model code and at least one training data from an artificial intelligence being examined;
configuring the method to access at least one invoke model when the at least one model code and/or the at least one training data from the artificial intelligence being examined is unavailable;
processing at least one input data to extract at least one protected feature;
providing the invoke model with at least one input data and at least one causal setup to obtain at least one output;
checking for at least one confounder vis-à-vis the at least one input data and the at least one output of the model;
assigning at least one relative rating to the artificial intelligence being examined; and
assigning at least one total ordered rating artificial intelligence being examined.

12. The method to generate trust certificates for artificial intelligence systems as blackbox and whitebox settings of claim 11, wherein the data comprises text, sound, image, video, structured or a combination of the above.

13. The method of to generate trust certificates for artificial intelligence systems as blackbox and whitebox settings of claim 11, wherein the at least one confounder comprises gender, race, region, religion and/or combinations of the above.

14. The method to generate trust certificates for artificial intelligence systems as blackbox and whitebox settings of claim 11 wherein the trust certificates are composable.

15. The method to generate trust certificates for artificial intelligence systems as blackbox and whitebox settings of claim 11 wherein the at least one relative rating and the at least one total ordered rating are used with a health or food application.
